(19) United States
(12) Patent Application Publication
(10) Pub. No.: US 2025/0106758 A1
(43) Pub. Date: Mar. 27, 2025

(54) METHOD AND APPARATUS FOR POWER SAVING IN MOBILE WIRELESS COMMUNICATION SYSTEM

(71) Applicants: Soenghun KIM, Hanam-si (KR); BLACKPIN INC., Seoul (KR)

(72) Inventor: Soenghun KIM, Hanam-si (KR)

(21) Appl. No.: 18/893,451

(22) Filed: Sep. 23, 2024

(30) Foreign Application Priority Data
Sep. 25, 2023 (KR) 10-2023-0128105

(51) Int. Cl. H04W 52/02; H04W 76/27

(52) U.S. Cl. CPC H04W 52/0209; H04W 76/27

(57) ABSTRACT

A solution for monitoring low power signal in RRC_INACTIVE state is provided. The solution provides means to monitor low power signal to determine whether to switch to main receiver from low power receiver. With this solution, the terminal stays in low power state as much as possible that results in reduced battery power consumption.

### CROSS-REFERENCE TO RELATED APPLICATION

This application claims priority to and the benefit of Korean Patent Application No. 10-2023-0128105, filed on Sep. 25, 2023, the disclosure of which is incorporated herein by reference in its entirety.

### BACKGROUND

### Technical Field

The present disclosure relates to receiver switching for power saving, specifically, method and apparatus for receiving low power wake-up signal in mobile wireless communication system.

### Related Art

5G systems are designed and developed targeting for various vertical use cases. Key performance indicators for 5G systems are latency, reliability, data rate and UE energy efficiency. In general, 5G devices consume tens of milliwatts in RRC_INACTIVE/RRC_IDEL state and hundreds of milliwatts in RRC_CONNECTED state. By reducing energy consumption, better user experience is achievable as less battery rechanges are required.

The power consumption is heavily affected by the configured length of duty cycle, e.g., paging cycle. To meet the longer battery life requirements, eDRX cycle with large value is expected to be used, resulting in high latency, which is not suitable for such services with requirements of both long battery life and low latency. It is desirable to support ultra-low power mechanism that can support low latency.

Currently, UEs need to periodically wake up once per DRX cycle, which dominates the power consumption in periods with no signalling or data traffic. If UEs are able to wake up only when they are triggered, e.g., paging, power consumption could be significantly reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on.

In the present disclosure, method and apparatus for low power consumption with reasonable latency. It is achieved by interplaying main radio (MR) component and low power receiver (LR) such that the main radio consumes power only when necessary.

### SUMMARY

Aspects of the present disclosure are to provide the method and apparatus to enable power saving based on low power receiver. The method of the terminal includes receiving from AMF a downlink message comprising a first parameter related to receiver switching signal, receiving from a base station a second downlink message instructing state transition to RRC_INACTIVE state, receiving a SIB1 comprising a second parameter related to receiver switching signal, determining that a first information is associated with the terminal based on the first parameter and the second parameter, receiving a receiver switching signal comprising the first information and receiving a specific paging occasion.

### BRIEF DESCRIPTION OF THE DRAWINGS

FIG. 1A is a diagram illustrating the architecture of an 5G system and a NG-RAN.

FIG. 1B is a diagram illustrating a wireless protocol architecture in an 5G system.

FIG. 1C is a diagram illustrating state transitions.

FIG. 2A illustrates overall operation of the UE and network.

FIG. 2B PLMN selection/Cell Selection/Reselection.

FIG. 2C illustrates RRC connection release procedure.

FIG. 2D illustrates RRC connection resumption procedure.

FIG. 2E illustrates RRC connection resumption procedure.

FIG. 2F illustrates RRC connection resumption procedure.

FIG. 3A illustrates operation of UE and base station with regards to LP-SS.

FIG. 3B illustrates operation of UE and base station for LP-WUS.

FIG. 3C is a diagram illustrating paging monitoring and DRX in RRC_IDLE and RRC_INACTIVE.

FIG. 3D is a diagram illustrating WUS burst and WUS Time Window.

FIG. 4A is a flow diagram illustrating an operation of a terminal.

FIG. 4B is a flow diagram illustrating an operation of a base station.

FIG. 5A is a block diagram illustrating the internal structure of a terminal.

FIG. 5B is a block diagram illustrating the configuration of a base station.

### DETAILED DESCRIPTION

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, followings are used interchangeably:
MR and main receiver and main radio;
LR and lower power receiver and lower power radio;
T_DRX_RAN and UE specific DRX value configured by RRC; and
T_DRX_CN and UE specific DRX value configured by upper layers

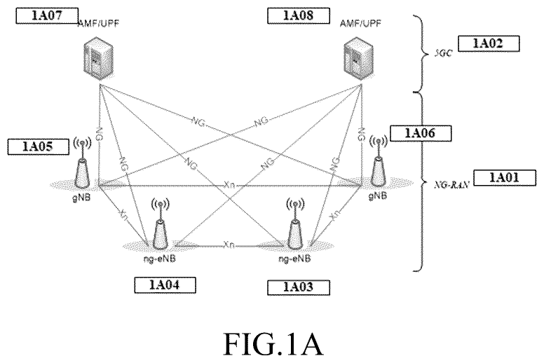

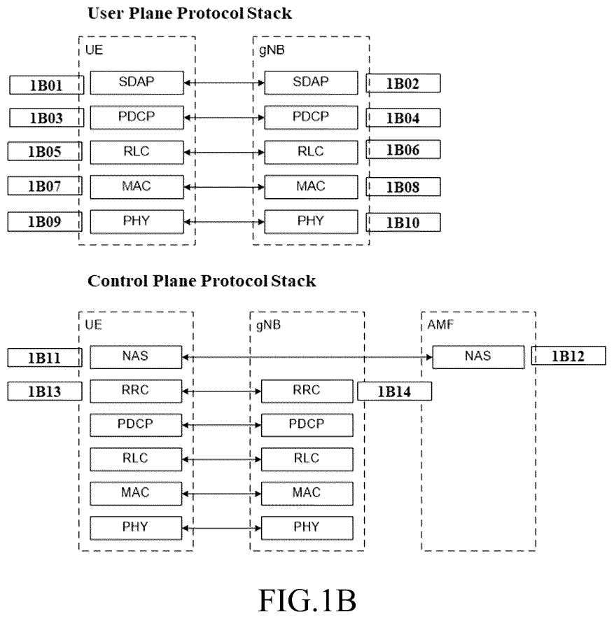

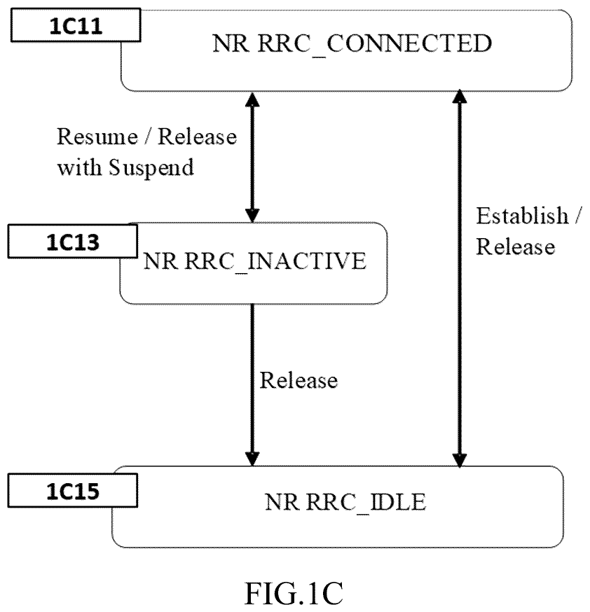

FIG. 1A is a diagram illustrating the architecture of an 5G system and a NG-RAN to which the disclosure may be applied.

5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below:

Functions for Radio Resource Management such as Radio Bearer Control, Radio Admission Control, Connection Mobility Control, Dynamic allocation of resources to UEs in uplink, downlink and sidelink (scheduling); IP and Ethernet header compression, uplink data decompression and encryption of user data stream; Selection of an AMF at UE attachment when no routing to an MME can be determined from the information provided by the UE; Routing of User Plane data towards UPF; Scheduling and transmission of paging messages; Scheduling and transmission of broadcast information (originated from the AMF or O&M); Measurement and measurement reporting configuration for mobility and scheduling; Session Management; QoS Flow management and mapping to data radio bearers; Support of UEs in RRC_INACTIVE state.

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

FIG. 1C is a diagram illustrating an RRC state transition.

Between RRC_CONNECTED 1C11 and RRC_INACTIVE 1C13, a state transition occurs by the exchange of the Resume message and the Release message containing the Suspend IE.

A state transition occurs between RRC_CONNECTED 1C11 and RRC_IDLE 1C15 through RRC connection establishment and RRC connection release.

The UE supports three RRC states.

In RRC_IDLE, UE has no RRC connection with RAN. The UE monitors paging channel and idle mode mobility (UE based mobility). As name implies, in RRC_IDLE state, data transmission/reception is not possible and power consumption is minimal. To perform data transfer, UE is required to transition to RRC_CONNECTED state.

In RRC_CONNECTED, UE has valid RRC connection with RAN. The UE establishes radio bearer configured for data transmission/reception. UE mobility is handled by network-controlled handover. RRC_CONNECTED state is most power-consuming state. To minimize power consumption during this state, C-DRX and other technique can be applied.

In RRC_INACTIVE, UE has suspended RRC connection with RAN. Before performing full scale data transfer, the UE and the base station resume the suspended RRC connection. UE mobility is handled by idle mode mobility within RAN defined area. If UE is capable of and configured by the base station, data transfer in limited scale can be performed in RRC_INACTIVE state, which is called small data transmission procedure.

RRC_IDLE state can be characterized with followings:
>1: PLMN selection; Broadcast of system information;
>1: Cell re-selection mobility;
>1: Paging for mobile terminated data is initiated by 5GC;
>1: DRX for CN paging configured by NAS.

RRC_INACTIVE state can be characterized with followings:
>1: PLMN selection; Broadcast of system information;
>1: Cell re-selection mobility;
>1: Paging is initiated by NG-RAN (RAN paging);
>1: RAN-based notification area (RNA) is managed by NG-RAN;
>1: DRX for RAN paging configured by NG-RAN;
>1: 5GC-NG-RAN connection (both C/U-planes) is established for UE;
>1: The UE AS context is stored in NG-RAN and the UE;
>1: NG-RAN knows the RNA which the UE belongs to.

RRC_CONNECTED state can be characterized with followings:
>1: 5GC-NG-RAN connection (both C/U-planes) is established for UE;
>1: The UE AS context is stored in NG-RAN and the UE;
>1: NG-RAN knows the cell which the UE belongs to;
>1: Transfer of unicast data to/from the UE;
>1: Network controlled mobility including measurements.

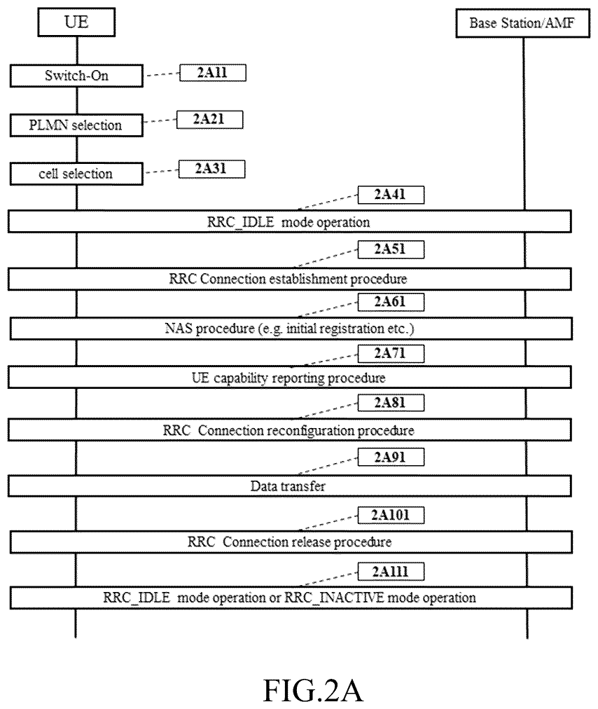

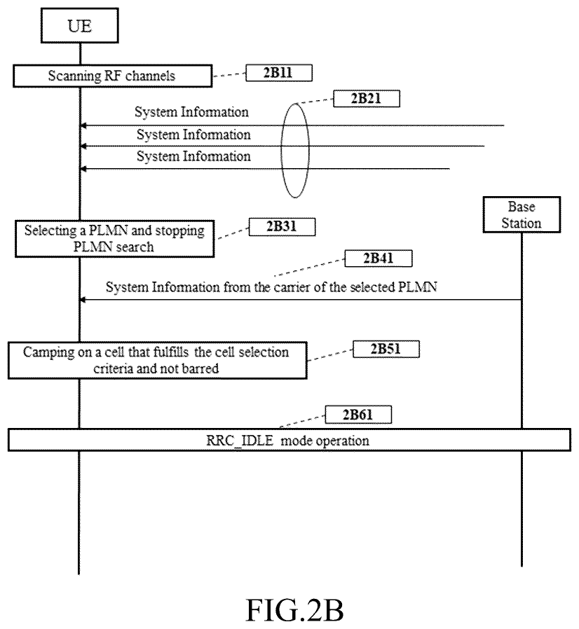

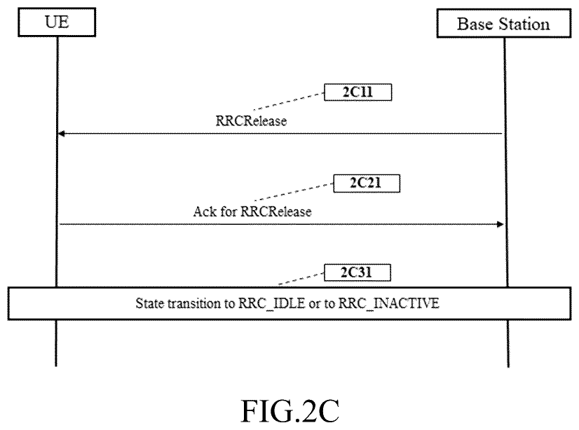

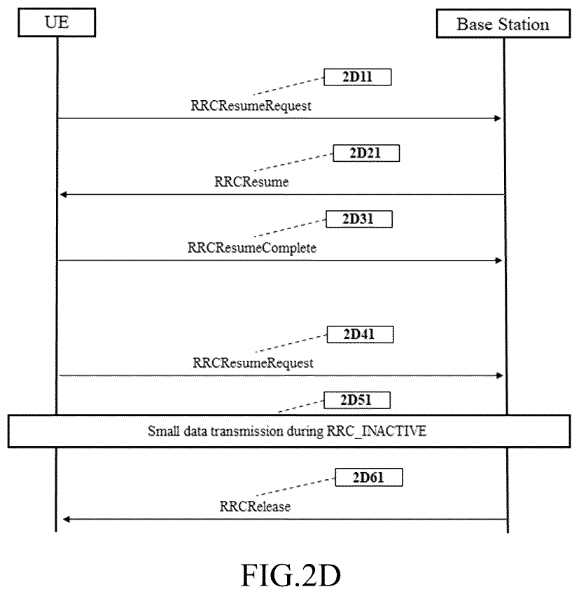

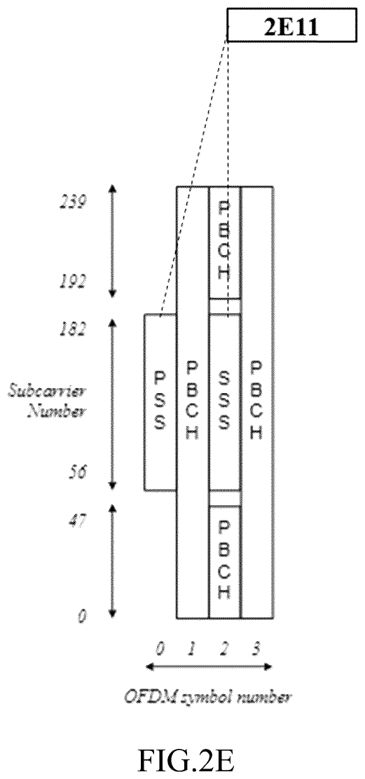

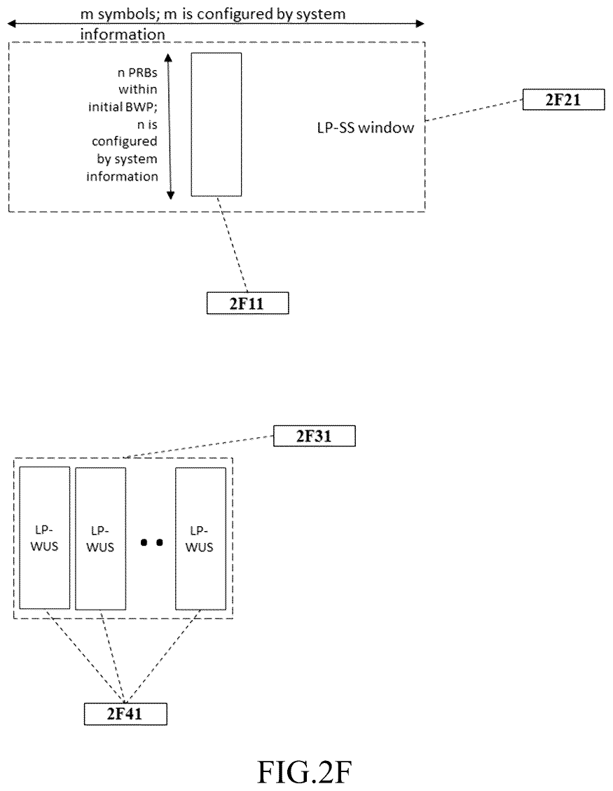

FIG. 2A illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is not longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

FIG. 2B illustrates the operation of the UE regarding PLMN selection and cell selection and cell reselection.

For PLMN selection, the UE may scan all RF channels to find available PLMNs 2B11. On each carrier, the UE shall search for the strongest cell and read its system information 2B21, in order to find out which PLMN(s) the cell belongs to. Each found PLMN is considered as a high quality PLMN (but without the RSRP value) provided that the measured RSRP value is greater than or equal to −110 dBm.

The search for PLMNs may be stopped when the PLMN to which the UE can register is found 2B31.

Once the UE has selected a PLMN, the cell selection procedure shall be performed in order to select a suitable cell of that PLMN to camp on.

The UE performs measurement on detectable cells and receives system information from whichever detectable cells that system information is readable 2B41.

The UE consider cell selection criterion S is fulfilled when:
Srxlev>0 AND
Squal>0
where, Srxlev is Cell selection RX level value (dB) and Squal is Cell selection quality value (dB). Srxlev is determined based on Measured cell RX level value (RSRP). Squal is determined based on Measured cell quality value (RSRQ).

The UE selects the cell that is part of the selected PLMN, and for which cell selection criteria are fulfilled, and of which cell access is not barred 2B51.

The UE camps on the selected cell. The UE perform RRC_IDLE mode operation 2B61 such as monitoring control channels to receive system information and paging and notification message.

FIG. 2C illustrates RRC connection release procedure.

RRC connection release procedure comprises:
>1: transmission of RRCRelease from the base station to the UE at 2C11; and
>1: transmission of acknowledgement for the RRCRelease from the UE to the base station at 2C21; and
>1: state transition from RRC_CONNECTED to either RRC_IDLE or RRC_INACTIVE at 2C31.

The purpose of RRC connection release procedure is either to release RRC connection (state transition to RRC_IDLE) or to suspend RRC connection (state transition to RRC_INACTIVE).

RRC connection release procedure may perform, in addition to state transition, various roles e.g., providing redirection information or providing cell reselection priorities. The RRCRelease may comprise following fields for redirection:
>1: redirectedCarrierInfo field comprises RedirectedCarrierInfo IE;
>>2: RedirectedCarrierInfo IE comprises either CarrierInfoNR IE or RedirectedCarrierInfo-EUTRA IE;
>>>3: CarrierInfoNR IE comprises ARFCN-ValueNR IE and SubcarrierSpacing IE; The UE may perform cell selection on the carrier indicated by CarrierInfoNR IE or RedirectedCarrierInfo-EUTRA IE.

The RRCRelease may comprise following fields to configure cell reselection priority:
>1: cellReselectionPriorities field comprises CellReselectionPriorities IE;
>>2: CellReselectionPriorities IE comprises:
>>>3: FreqPriorityListNR IE;
>>>3: t320 field indicates a timer value for cell reselection priority validity;
During idle mode mobility, the UE applies the CellReselectionPriorities until T320 expires or stops.

The RRCRelease may comprises following fields/IEs to transition UE to RRC_INACTIVE state:
>1: suspendConfig field comprises SuspendConfig 1E;
>>2: fullI-RNTI field comprises I-RNTI-Value IE;
>>2: shortI-RNTI field comprises ShortI-RNTI-Value IE;
>>2: ran-PagingCycle field comprises PagingCycle IE;
>>2: ran-NotificationAreaInfofield comprises RAN-NotificationAreaInfo IE;
>>2: t380 field comprises PeriodicRNAU-TimerValue;
>>2: nextHopChainingCount field comprises NextHopChainingCount IE.
>>2: ran-ExtendedPagingCycle field comprises ExtendedPagingCycle IE.

To transit the UE to RRC_INACTIVE, the base station includes SuspendConfig 1E in the RRCRelease. To transit the UE to RRC_IDLE, the base station does not include SuspendConfig 1E in the RRCRelease.

Upon reception of RRCRelease, UE may:
>1: delay the actions caused by RRCRelease 60 ms from the moment the RRCRelease message was received or optionally when lower layers indicate that the receipt of the RRCRelease message has been successfully acknowledged, whichever is earlier;
>1: store the cell reselection priority information provided by the cellReselectionPriorities and start T320;
>1: if the RRCRelease includes suspendConfig:
>>2: reset MAC and release the default MAC Cell Group configuration;
>>2: apply the received suspendConfig except the received nextHopChainingCount;
>>2: if the sdt-Config is configured:
>>>3: for each of the DRB in the sdt-DRB-List, consider the DRB to be configured for SDT;
>>>3: if sdt-SRB2-Indication is configured, consider the SRB2 to be configured for SDT;
>>>3: re-establish the RLC entity for each RLC bearer that is not suspended;
>>>3: trigger the PDCP entity to perform SDU discard for SRB1 and SRB2;
>>>3: if sdt-MAC-PHY-CG-Config is configured, configure the PCell with the configured grant resources for SDT and start the cg-SDT-TimeAlignmentTimer;
>>3: if srs-PosRRC-Inactive is configured, apply the configuration and instruct MAC to start the inactivePosSRS-TimeAlignmentTimer;
>>2: re-establish RLC entities for SRB1;
>>2: stop the timer T319 if running;
>>2: store in the UE Inactive AS Context the nextHopChainingCount received in the RRCRelease message, the current KgNB and KRRCint keys, the ROHC state, the EHC context(s), the UDC state, the stored QoS flow to DRB mapping rules, the application layer measurement configuration, the C-RNTI used in the source PCell, the cellIdentity and the physical cell identity of the source PCell, the spCellConfigCommon within ReconfigurationWithSync of the NR PSCell (if configured) and all other parameters configured except for:
>>>3: parameters within Reconfiguration WithSync of the PCell;
>>>3: parameters within Reconfiguration WithSync of the NR PSCell, if configured;
>>>3: parameters within MobilityControlInfoSCG of the E-UTRA PSCell, if configured;
>>>3: servingCellConfigCommonSIB;
>>2: suspend all SRB(s) and DRB(s) and multicast MRB(s), except SRB0 and broadcast MRBs;
>>2: indicate PDCP suspend to lower layers of all DRBs and multicast MRBs;
>>2: start timer T380, with the timer value set to t380;
>>2: indicate the suspension of the RRC connection to upper layers;
>>2: enter RRC_INACTIVE and perform cell selection;
>1: else (if the RRCRelease does not include suspendConfig):
>>2: perform the actions upon going to RRC_IDLE;

FIG. 2D illustrates RRC connection resumption procedure.

RRC connection resume procedure, in case of state transition from RRC_INACTIVE to RRC_CONNECTED, consists of RRC message exchange between the UE and the base station: RRCResumeRequest 2D11 and RRCResume 2D21 and RRCResumeComplete 2D31.

RRC connection resume procedure, in case of small data transmission without state transition, consists of RRC message exchange between the UE and thee base station: RRCResumeRequest 2D41 and RRCRelease 2D51.

RRC connection resume procedure is triggered by the UE due to various reasons. For example, RRC connection resume procedure for state transition is triggered periodically (upon T380 expiry) or event-driven (upon cell change to different RAN area) or data driven (upon uplink or downlink data arrival). RRC connection resume procedure for small data transmission is triggered only if channel condition is above specific threshold and the amount of data is expected to be relatively small.

Upon initiation of RRC connection resume procedure, the UE performs some preliminary operation such as starting timers such as T319 (for supervising the procedure) and timeAlignmentTimer (for uplink timing alignment) and applying common channel configuration (for transmission of RRCResumeRequest). Then UE transmits RRCResumeRequest 2D11 or 2D41 to the base station. The message comprises the UE identifier which can be used by the base station to identify the UE context where RRC connection information of the UE is stored.

When the base station determines that UE needs to be in RRC_CONNECTED state, the base station transmits RRCResume. Upon reception of RRCResume 2D21, the UE restores whole UE context based on the stored context at the time of RRCRelease reception and the received information in the RRCResume.

If the RRC connection resume procedure is triggered for small data transmission, the UE and the base station may perform data transfer during RRC connection resume procedure 2D51. When the base station determines that small data transmission is finished, the base station transmit RRCRelease 2D61.

FIG. 2E is a diagram illustrating SSB and PSS/SSS.

The Synchronization Signal and PBCH block (SSB) consists of primary and secondary synchronization signals (PSS, SSS) 2E11, each occupying 1 symbol and 127 subcarriers, and PBCH spanning across 3 OFDM symbols and 240 subcarriers, but on one symbol leaving an unused part in the middle for SSS. For the 3 MHz channel bandwidth, the PBCH is further equally punctured from both edges to span 144 subcarriers. The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Within the frequency span of a carrier, multiple SSBs can be transmitted. The PCIs of SSBs transmitted in different frequency locations do not have to be unique, i.e. different SSBs in the frequency domain can have different PCIs. However, when an SSB is associated with an RMSI, the SSB is referred to as a Cell-Defining SSB (CD-SSB). A PCell is always associated to a CD-SSB located on the synchronization raster.

FIG. 2F is a diagram illustrating LP-SS and LP-WUS.

Low Power-Synchronization signal 2F11 is transmitted during a LP-SS window 2F-21. LP-SS window occurs periodically. The length and the periodicity and starting time position of LP-SS window are configured by system information. The number of PRBs of LP-SS is configured by a first parameter in SIB1. The possible time locations of LP-SS (e.g. LP-SS window) is configured by a second parameter in SIB1. Alternatively, A third parameter can jointly configure time location and frequency location together.

A LP-WUS burst 2F31 consists of plurality of LP-WUSs 2F41. Each LP-WUS carries information about wake-up. The information about wake-up could be a specific sequence that is associated with one or more UE sub-groups. Frequency location/resource of LP-WUS is indicated by system information. The number of LP-WUSs per LP-WUS burst is also indicated by system information.

To receive downlink signal properly, downlink synchronization is required. For MR, UE establishes downlink synchronization based on PSS and SSS embedded in SSB. For LR, since MR and LR are separate components and process different downlink signals, separate synchronization is required. Downlink synchronization for LR is established based on LP-SS. For downlink synchronization for MR, UE may blindly search SSBs without assistance information provided in advance. Blind synchronization is not efficient way in a sense that it takes latency and UE battery consumption. Instead of blind synchronization, downlink synchronization for LP-SS is performed based on system information assisted way.

UE identifies from system information rough time window during when LP-SSs are transmitted. UE performs quick synchronization for LP-SS based on the rough time window.

For power saving purpose, followings are important:
minimizing the duration when the MR is active; and
minimizing the transition between MR and LR.

In the present invention:
the duration when the MR is active (or on) and LR is inactive (or off) is denoted as a first-time-duration; and
the duration when the LR is active (or on) and MR is inactive (or off) is denoted as a second-time-duration.

The first-time-duration and the second-time-duration alternate. During the first-time-duration, MR is used to periodically receive/measure SSB bursts. During the second-time-duration, LR is used to periodically receive/measure LP-SS. During the first-time-duration, MR is kept to active/on state and LR is kept to off state. During the second-time-duration, MR is in deep sleep and LR is on. During the first-time-duration, UE receives/measures SSB burst based on SSB-MTC and ssb-PositionsInBurst. During the second-time-duration, UE receives/measures LP-SS based on LP_SS_Timing_Configuration. LP-SS is processed based on a code sequence corresponding to short PCI and PSS/SSS is processed based on a code sequence corresponding to PCI.

The parameters that indicate the frequency resource on which the LP-SS is transmitted are transmitted via system information.

The waveform of LP-SS is on/off keying (OOK) and the waveform of SSB is orthogonal frequency division multiplexing (OFDM).

The UE determines the SS-RSRP and SS-RSRQ of n SSBs at a predetermined interval and selects one of them. The UE determines the RSRP of a single LP-SS every other predetermined interval. The LP-SS does not have a beam, and the SSB has a beam.

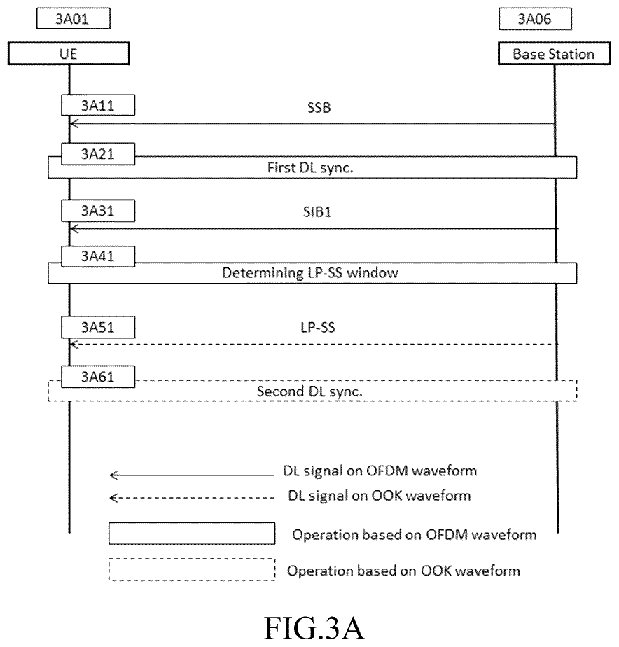

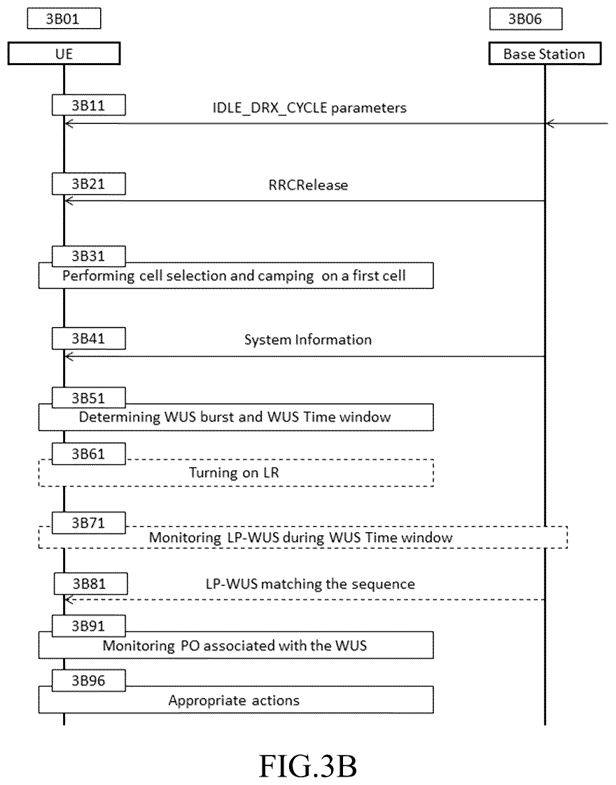

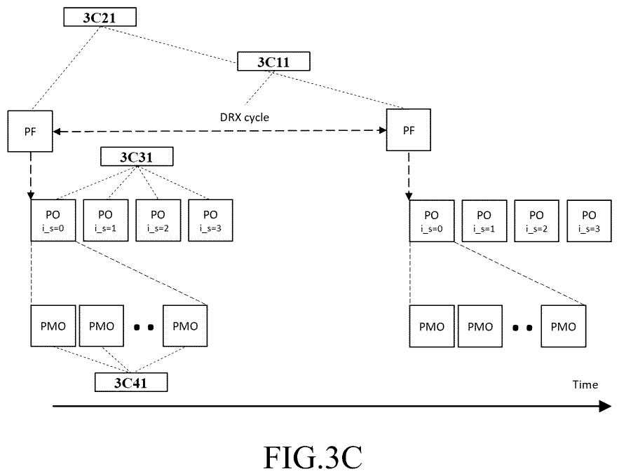

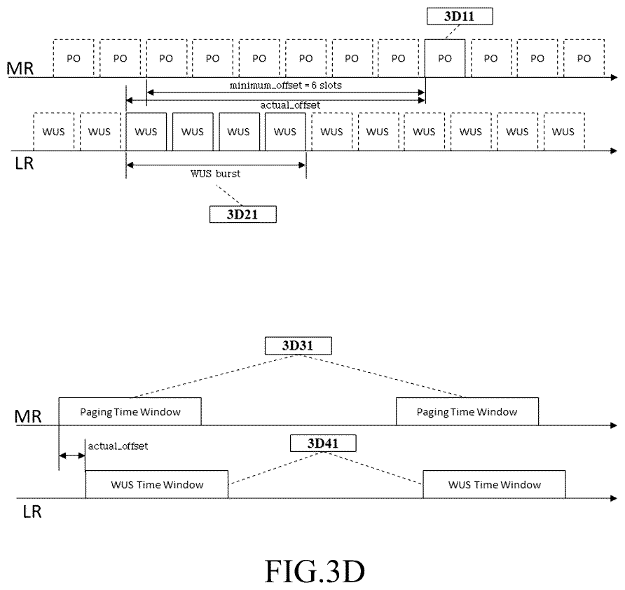

FIG. 3A illustrates operation of UE and base station for LP-SS.

UE 3A01 camp on a first cell. UE receive from a base station 3A06 one or more SSBs in the first cell 3A11. A SSB comprises PSS/SSS/PBCH.

UE establishes first downlink time synchronization (for Main Receiver) based on PSS/SSS in the SSB 3A21. UE determines frame boundary and symbol boundary based on the received PSS/SSS. UE determines PCI based on the sequence within PSS and SSS.

UE determines SFN of each frame from PBCH DM-RS and MIB. PBCH comprise MIB and PBCH DM-RS.

UE receives SIB1 based on MIB 3A31.

UE determines the lower power sync signal window based on a first information (e.g. LP_SS_Timing_Configuration) 3A41. Based on the first information, UE determines SFN and frame boundary and symbol boundary and a length of LP-SS window.

The first information comprises a first integer (indicating the frame number for LP-SS window start) and a second integer (indicating the symbol number for LP-SS window start) and a third value representing a periodicity. The first frame of the LP-SS window starts at the radio frame where [the corresponding SFN mod first integer=0] is satisfied. The first symbol of the LP-SS window starts at the symbol of which symbol number is equal to second integer. LP-SS window has fixed size of 0.5. LP-SS window occurs every periodicity.

Alternatively, a first parameter indicating both periodicity and offset and a second parameter indicating the duration is provided in LP_SS_Timing_Configuration.

The parameters indicating the starting point of LP-SS window indicates a specific time point defined based on OFDM waveform, while downlink signal associated with the LP-SS window is processed based on OOK waveform.

UE determines the frequency resource of LP-SS based on a second information. The first information and the second information are comprised in SIB1 to facilitate quick synchronization. The second information comprises an integer indicating one or more PRBs of the initial BWP. Alternatively, LP-SS window and LP-SS frequency resource are defined with an index representing specific time/frequency resource (e.g. searchSpaceId). For example, in case that LP_SS_Timing_Configuration comprises a searchSpaceId x, LP-SS is transmitted in the time/frequency region that are defined by the corresponding SearchSpace and associated CORESET.

UE determine the code resource of LP-SS (or sequence applied to LP-SS) based on the PSS sequence and SSS sequence. PCI is determined from the PSS sequence and the SSS sequence. LP-SS sequence is determined from a short PCI (y LSBs of PCI or PCI mod x). 2\hat{ }y sequences or x sequences are predefined. Each of the predefined sequences corresponds to a short PCI.

UE performs measurement on SSB. When a set of conditions are fulfilled, UE starts LR (Low Power Receiver) to receive LP-SS in a LP-SS window 3A51.

UE receives LP-SS based on the LP-SS window and LP-SS frequency resource and LP-SS code resource.

UE establishes second downlink time synchronization (for Low Receiver) based on the received LP-SS 3A-61. UE considers LP-SS occurs every periodicity. UE performs RSRP measurement on the LP-SS. UE monitors wake up signal using the LR when the RSRP of LP-SS is greater than a predefined threshold.

There are 1008 unique physical-layer cell identities which is given by:

$$N\_cell \_ID = 3 * N\_ ( 1 ) \_ID + N\_ ( 2 ) \_ID ,$$

where:
N_(1)_ID is derived from Secondary Synchronization Signal (SSS) and its range is from {0, 1 . . . 335}; and
N_(2)_ID is derived Primary Synchronization Signal (PSS) and its range is from {0, 1, 2}.

There are 33 short PCIs which is given by modulo operation of PCI or by taking predefined number of LSBs of PCI. UE determines PCI by determining which PSS sequence and SSS sequence are used in the PSS/SSS. UE tests multiple sequences for PSS and multiple sequences for SSS in detecting/acquiring PSS/SSS (or establishing first downlink time sync). UE tests only one sequence for LP-SS in detecting/acquiring LP-SS (establishing second time sync). UE determines the rough time duration/window for LP-SS based on the information in SIB1. UE determines exact timing for LP-SS by searching LP-SS during the rough time duration/window. Once the exact timing for LP-SS is determined, UE determines timings for subsequent LP-SSs based on the periodicity.

FIG. 3B illustrates operation of UE and base station for LP-WUS.

The LP-SS does not provide a separate frame number, which causes that UE is not able to determine the exact time point of WUS based on LP-SS timing. UE determines the exact time point of WUS based on paging frame (PF) and paging occasion (PO) and a configured offset.

After determining the PF and PO, the device determines that the first PO (or PF) corresponding to SSB0 and that the n WUS occasions from the first WUS occasion at an offset distance are the WUS occasions to be monitored.

WUS can indicates a single sequence. The terminal monitors the sequences corresponding to its sub-group and the special sequences. If either of them is detected, it will transition to MR-based behavior.

The following information is provided as system information.
>1: sub-group information;
>1: mapping relationships between sub-groups and sequences;
>1: the minimum time interval (offset_WUS_burst or minimum_offset) between the first PO and the first WUS occasion (or first WUS burst);
>1: the number of WUS occasions included in a WUS burst;
>1: Frequency range of LP-WUS (in the absence of this information, use the same frequency range as LP-SS).

UE wakes up if at least one WUS of WUS burst instruct wake-up. Alternatively, UE wakes up if all WUSs instructs wake-up.

UE monitors WUS burst every paging cycle if UE identifies WUS burst. If eDRX and PTW are configured, the UE configures the WUS PTW and monitor the WUS only within the configured WUS PTW. WUS PTW is the time interval that precedes PTW by offset.

UE performs followings.

UE switches on MR. UE performs PLMN selection. Upon PLMN is selected, UE performs NAS procedure such as ATTACH/REGISTRATION to register to the PLMN.

UE acquires IDLE_DRX_CYCLE parameters (T_DRX_CN and T_E_DRX_CN) during the NAS procedure 3B11. IDLE_DRX_CYCLE parameters are comprised in a NAS message sent from a LMF to the UE. T_DRX_CN is UE specific DRX configured by upper layer.

After completion of the NAS procedure, the base station may decide to put the UE to RRC_INACTIVE state.

UE receives from the base station a RRCRelease message for state transition 3B21.

UE perform state transition to RRC_INACTIVE based on reception of RRCRelease. UE acquires INACTIVE_DRX_CYCLE parameters (T_DRX_RAN and T_E_DRX_RAN) comprised in the RRCRelease. T_DRX_RAN is UE specific DRX configured by RRC.

UE performs cell selection and camps on a first cell 3B31. UE receives system information 3B41.

UE acquires followings from the system information:
>1: HFN and SFN;
>1: parameters for PF/PO determination;
>1: parameters for PTW determination; and
>1: parameters for LP-WUS.

UE determines 3B51:
>1: the PF/PO based on the parameters for PF/PO determination;
>1: the subgroup for LP-WUS based on the parameters for LP-WUS;
>1: WUS burst associated with the PO based on minimum_offset and other parameters;
>1: the WUS Time window based on the actual_offset (derived from the minimum_offset and the beginning time point of the WUS burst) and the PTW; and
>1: the frequency resource for LP-WUS.

The subsequent WUS burst occurs with a determined T (T is determined based on default DRX cycle and T_DRX_CN and T_E_DRX_CN and T_DRX_RAN and T_E_DRX_RAN).

UE turns on the LR and put MR in the power saving mode (e.g. deep sleep mode or turning off) 3B61.

UE monitors, during the WUS Timing Window, LP-WUSs of the WUS burst for a configurable subgroup-specific-sequence and one or more predefined all-subgroup-sequences 3B71.

UE turns off the LP-WUR and turn on MR when either sequence is detected in at least one LP-WUS of one or more LP-WUSs of the WUS burst 3B81.

UE monitors the PO associated with the WUS burst 3B91.

UE takes appropriate actions based on the Short Message and Paging message received based on PDCCH of the PO 3B96.

The system information comprises:
>1: PCCH-Config;
>1: WUS-Config:
>>2: frequency resource parameters (at least followings):
>>>3: ARFCN IE indicating reference frequency (e.g. center frequency or lowest frequency) for the WUS frequency resource;
>>>3: bandwidth IE indicating the bandwidth of WUS frequency resource;
>>>3: PRBs of initial UL BWP that are used for LP-WUS;
>>>>4: if frequency resource parameters are absent, UE determines frequency resource of LP-WUS is same as frequency resource of LP-SS;
>>>>4: if some of frequency resource parameters are absent, UE determines frequency resource of LP-WUS based on frequency resource of LP-SS (for example only bandwidth IE is present, UE determines that the reference frequency of LP-WUS is same as the reference frequency of LP-SS);
>>2: time resource parameters (at least followings):
>>>3: minimum_offset: indicating the time distance between a PO and associated WUS burst;
>>>3: number of LP-WUSs within a WUS burst
>>2: code resource parameters:
>>>3: mapping between subgroup-specific-sequences and subgroups (instead of explicit configuration, subgroup-specific-sequence can be derived from a predefined equation and input parameters for the equation, while the input parameter may include short PCI and subgroup ID); and
>>2: SubgroupConfig:
>>>3: subgroupsNumPerPO.

To identify WUS bursts to be monitored, UE may:
>1: determine its PO to monitor 3D11;
>1: determine WUS burst 3D21 associated with the PO:
>>2: UE first determine the time point which is apart from the beginning time point of determined PO by minimum_offset in advance; and
>>2: UE determines the WUS burst of which the beginning time point of its first LP-WUS is closest (in advance) to the time point;
>1: determine the actual_offset:
>>2: the actual offset is the time distance between the first LP-WUS of the associated WUS burst and the determined PO; and
>1: determine the next WUS burst to monitor based on the DRX cycle.

When WUS indicates that UE should receive the PO, UE identifies the time location of the PO based on the actual_offset.

If PTW 3D31 is configured for the UE, UE determines WTW (WUS Time Window) based on the actual_offset.

UE may:
>1: determine the beginning timing point of WTW 3D41 which is apart from the beginning time point of the PTW by actual_offset; and
>1: determine the length of WTW which is same as the PTW.

During a WUS burst, UE monitors a subgroup-specific-sequences and an all-subgroup-sequence. The length of the sequence is fixed (e.g. 4 bit). Each sequence is generated by a subgroup identity and a short PCI.

UE determines a subgroup that the UE belongs to based on SubgroupConfig in the system information and a subgroup ID assigned by AMF.

UE may generate the subgroup-specific-sequence based on the determined subgroup identity (e.g. SubgroupID) and short PCI that is indicated by LP-SS.

UE may generate the all-subgroup-sequence based on a specific subgroup identity (that is subgroupsNumPerPO+fixed integer) and short PCI. Alternatively, all-subgroup-sequence could be fixed in the specification.

UE may generate the subgroup-specific-sequence based on the determined subgroup identity (e.g. SubgroupID+number of all-subgroup-sequences+1) and short PCI that is indicated by LP-SS.

The base station transmits all-subgroup-sequence in case when it is necessary to:
>1: notify more than one subgroups to check the associated PO; or
>1: indicate BCCH modification other than SIB6, SIB7, SIB8; or
>1: indicate ETWS primary notification and/or an ETWS secondary notification.

It is possible to define more than one all-subgroup-sequences to indicate the limit the scope of notification (so that only subset of UEs to wake-up).

For example:
>1: first all-subgroup-sequence is to cause all UEs detecting the sequence to check the associated PO;
>1: second all-subgroup-sequence is to cause a first subset of UEs detecting the sequence to check the associated PO:
>>2: the first subset of UEs could be:
>>>3: UEs not configured with IDLE eDRX cycle longer than the modification period; or
>>>3: UEs configured with DRX cycle smaller than the modification period
>1: third all-subgroup-sequence is to cause a second subset of UEs detecting the sequence to check the associated PO;
>>2: the second subset of UEs could be:
>>>3: UEs configured with IDLE eDRX cycle longer than the modification period; or
>>>3: UEs configured with DRX cycle longer than the modification period;
>1: fourth all-subgroup-sequence is to cause a third subset of UEs detecting the sequence to check the associated PO;
>>2: the third subset of UEs could be:
>>>3: UEs configured to receive positioning system information (interested in receiving positioning system information).

UE is required to, during WTSs, monitor in WUS burst whether one of its target sequences is detected. Target sequences are determined as below.
>1: Target sequences for the first subset of UEs:
>>2: subgroup-specific-sequence; and
>>2: the first all-subgroup-sequence; and
>>2: the second all-subgroup-sequence;
>1: Target sequences for the second subset of UEs:
>>2: subgroup-specific-sequence; and
>>2: the first all-subgroup-sequence; and
>>2: the third all-subgroup-sequence;
>1: Target sequences for UEs that belongs to the first subset of UEs and the third subset of UEs:
>>2: subgroup-specific-sequence; and
>>2: the first all-subgroup-sequence; and
>>2: the second all-subgroup-sequence; and
>>2: the fourth all-subgroup-sequence;
>1: Target sequences for UEs that belongs to the second subset of UEs and the third subset of UEs:
>>2: subgroup-specific-sequence; and
>>2: the first all-subgroup-sequence; and
>>2: the third all-subgroup-sequence; and
>>2: the fourth all-subgroup-sequence.

For LP-WUSs of a WUS burst:
>1: if none of target sequences are detected in none of LP-WUSs of the WUS burst (e.g. if no sequences are detected in all LP-WUSs of the WUS burst, or if sequences detected at least once in LP-WUSs of the WUS burst are different from target sequences);
>>2: UE does not switch to MR mode (MR on/active; LR off/sleep/deactivated) and stay in LR mode (LR on/active; MR off/sleep/deactivated);
>>2: UE does not monitor the PO associated with the WUS burst;
>1: if at least one of target sequences are detected in at least one of LP-WUSs of the WUS burst;
>>2: UE switches from LR MODE to MR mode;
>>2: UE monitor the PO associated with the WUS burst.

FIG. 3C illustrates paging monitoring and DRX in RRC_IDLE and RRC_INACTIVE.

The UE may use Discontinuous Reception (DRX) in RRC_IDLE and RRC_INACTIVE state in order to reduce power consumption. The UE monitors one paging occasion (PO) per DRX cycle 3C11. A PO 3C31 is a set of PDCCH monitoring occasions (PMOs) 3C41 and can consist of multiple time slots (e.g. subframe or OFDM symbol) where paging DCI can be sent. One Paging Frame (PF) 3C21 is one Radio Frame and may contain one or multiple PO(s) or starting point of a PO.

In multi-beam operations, the UE assumes that the same paging message and the same Short Message are repeated in all transmitted beams and thus the selection of the beam(s) for the reception of the paging message and Short Message is up to UE implementation. The paging message is same for both RAN initiated paging and CN initiated paging.

The UE initiates RRC Connection Resume procedure upon receiving RAN initiated paging. If the UE receives a CN initiated paging in RRC_INACTIVE state, the UE moves to RRC_IDLE and informs NAS.

The PF and PO for paging are determined by the following formulae:

SFN for the PF is determined by:

$$( SFN + PF\_offset ) mod T = T div N ) * ( UE\_ID mod N ) .$$

Index (i_s), indicating the index of the PO is determined by:

$$i\_s = floor ( UE\_ID / N ) mod Ns .$$

The PDCCH monitoring occasions for paging are determined according to pagingSearchSpace and firstPDCCH-MonitoringOccasionOfPO and nrofPDCCH-MonitoringOccasionPerSSB-InPO if configured.
>1: SIB1/ServingCellConfigCommonSIB/BWP-UplinkCommon/PDCCH-ConfigCommon/pagingSearchSpace;
>>2: ID of the search space for paging. If the field is absent, the UE does not receive paging in this BWP (e.g. initial BWP);
>1: SIB1/ServingCellConfigCommonSIB/PCCH-Config/firstPDCCH-MonitoringOccasionOfPO;
>>2: Indicates the first PDCCH monitoring occasion of each PO of the PF on this BWP (e.g. initial BWP);
>1: SIB1/ServingCellConfigCommonSIB/PCCH-Config/nrofPDCCH-MonitoringOccasionPerSSB-InPO;
>>2: The number of PDCCH monitoring occasions corresponding to an SSB within a Paging Occasion.

The UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K] ^{th} PDCCH monitoring occasion for paging in the PO corresponds to the Kth transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

The following parameters are used for the calculation of PF and i_s above:
>1: T is DRX cycle of the UE.
>>2: If the UE does not operate in eDRX:
>>>3: T is determined by the shortest of the UE specific DRX value(s), if configured by RRC and/or upper layers and a default DRX value broadcast in system information. In RRC_IDLE state, if UE specific DRX is not configured by upper layers, the default value is applied.
>>2: In RRC_IDLE state, if the UE operates in eDRX and eDRX is configured by upper layers, i.e., T_E_DRX_CN:
>>>3: If T_E_DRX_CN is no longer than 1024 radio frames:
>>>>4: T=T_E_DRX_CN;
>>>3: else:
>>>>4: During CN configured PTW, T is determined by the shortest of UE specific DRX value, if configured by upper layers, and the default DRX value broadcast in system information.
>>2: In RRC_INACTIVE state, if the UE operates in eDRX and eDRX is configured by RRC, i.e., T_E_DRX_RAN, and/or upper layers, i.e., T_E_DRX_CN, as defined in clause 7.4:
>>>3: If both T_E_DRX_CN and used T_E_DRX_RAN are no longer than 1024 radio frames, T=min {T_E_DRX_RAN, T_E_DRX_CN}.
>>>3: If T_E_DRX_CN is no longer than 1024 radio frames and no T_E_DRX_RAN is configured or used, T is determined by the shortest of UE specific DRX value configured by RRC (T_DRX_RAN) and T_E_DRX_CN.
>>>3: If T_E_DRX_CN is longer than 1024 radio frames:
>>>>4: If T_E_DRX_RAN is not configured or used:
>>>>>5: During CN configured PTW, T is determined by the shortest of the UE specific DRX value(s), if configured by RRC and/or upper layers, and a default DRX value broadcast in system information. Outside the CN configured PTW, T is determined by the UE specific DRX value configured by RRC;
>>>>4: else if used T_E_DRX_RAN is no longer than 1024 radio frames:
>>>>>5: During CN configured PTW, T is determined by the shortest of the UE specific DRX value, if configured by upper layers and T_E_DRX_RAN, and a default DRX value broadcast in system information. Outside the CN configured PTW, T is determined by T_E_DRX_RAN.
>1: N is number of total paging frames in T
>1: Ns is number of paging occasions for a PF
>1: PF_offset is offset used for PF determination
>1: UE_ID is:
>>2: If the UE operates in eDRX:
>>>3: 5G-S-TMSI mod 4096
>>2: else:
>>>3: 5G-S-TMSI mod 1024

Parameters Ns, nAndPagingFrameOffset, nrofPDCCH-MonitoringOccasionPerSSB-InPO, and the length of default DRX Cycle are signaled in SIB1. The values of N and PF_offset derived from the parameter nAndPagingFrameOffset. The parameter firstPDCCH-MonitoringOccasionOfPO is signalled in SIB1 for paging in the BWP configured by initialDownlinkBWP. For paging in a DL BWP other than the BWP configured by initialDownlinkBWP, the parameter first-PDCCH-MonitoringOccasionOfPO is signaled in the corresponding BWP configuration.

If the UE has no 5G-S-TMSI, for instance when the UE has not yet registered onto the network, the UE shall use as default identity UE_ID=0 in the PF and i_s formulas above.

5G-S-TMSI is a 48 bit long bit string. 5G-S-TMSI shall in the formulae above be interpreted as a binary number where the left most bit represents the most significant bit.

In RRC_INACTIVE state, if the UE supports inactiveStatePO-Determination and the network broadcasts ranPagingInIdlePO with value “true”, the UE shall use the same i_s as for RRC_IDLE state. Otherwise, the UE determines the i_s based on the parameters and formula above.

In RRC_INACTIVE state, if used eDRX value configured by upper layers is no longer than 1024 radio frames, the UE shall use the same i_s as for RRC_IDLE state.

In RRC_INACTIVE state, if used eDRX value configured by upper layers is longer than 1024 radio frames, during CN PTW, the UE shall use the same i_s as for RRC_IDLE state.

### Subgrouping for LP-WUS

If LP-WUS and subgrouping are configured, UEs monitoring the same PO can be divided into one or more subgroups. With subgrouping, the UE monitors the associated PO if the sequence corresponding to the subgroup the UE belongs to is detected during the LP-WUS occasions corresponding to its PO.

The following parameters are used for the determination of subgroup ID:
>1: subgroupsNumPerPO: total number of subgroups for both CN assigned subgrouping (if any) and UE_ID based subgrouping (if any) in a PO, which is broadcasted in system information;
>1: subgroupsNumForUEID: number of subgroups for UE_ID based subgrouping in a PO, which is broadcasted in system information.

UE's subgroup can be either assigned by CN or formed based on UE_ID:
>1: If subgroupsNumForUEID is absent in subgroupConfig, the subgroup ID based on CN assigned subgrouping, if available for the UE, is used in the cell.
>1: If both subgroupsNumPerPO and subgroupsNumForUEID are configured, and subgroupsNumForUEID has the same value as subgroupsNumPerPO, the subgroup ID based on UE_ID based subgrouping is used in the cell.
>1: If both subgroupsNumPerPO and subgroupsNumForUEID are configured, and subgroupsNumForUEID<subgroupsNumPerPO:
>>2: The subgroup ID based on CN assigned subgrouping, if available for the UE, is used in the cell;
>>2: Otherwise, the subgroup ID based on UE_ID based subgrouping is used in the cell.

If a UE has no CN assigned subgroup ID or does not support CN assigned subgrouping, and there is no configuration for subgroupsNumForUEID, the UE monitors the associated PO.

Paging with CN assigned subgrouping is used in the cell which supports CN assigned subgrouping. A UE supporting CN assigned subgrouping in RRC_IDLE or RRC_INACTIVE state can be assigned a subgroup ID (between 0 to 7) by AMF through NAS signalling. The UE belonging to the assigned subgroup ID monitors a LP-WUS sequences corresponding to the subgroup during LP-WUS burst corresponding to the PO of the UE.

Paging with UE_ID based subgrouping is used in the cell which supports UE_ID based subgrouping.

If the UE is not configured with a CN assigned subgroup ID, or if the UE configured with a CN assigned subgroup ID is in a cell supporting only UE_ID based subgrouping, the subgroup ID of the UE is determined by the formula below:

$$SubgroupID = ( floor ( UE\_ID / ( N * Ns ) ) mod subgroupsNumForUEID ) + ( subgroupsNumPerPO - subgroupsNumForUEID ) ,$$

where:
N: number of total paging frames in T, which is the DRX cycle of RRC_IDLE state;
Ns: number of paging occasions for a PF;
UE_ID: 5G-S-TMSI mod X, where X is 32768, if eDRX is applied; otherwise, X is 8192;
subgroupsNumForUEID: number of subgroups for UE_ID based subgrouping in a PO, which is broadcasted in system information.

The UE belonging to the assigned subgroup ID monitors a LP-WUS sequences corresponding to the subgroup during LP-WUS burst corresponding to the PO of the UE.

The UE belonging to a subgroup ID monitors both subgroup specific LP-WUS sequence and a common LP-WUS sequence during the LP-WUS burst.

UE determines the sequence to be monitored in the WUS burst based on:
>1: the subgroupsNumPerPO;
>1: the subgroup ID assigned by AMF; and
>1: the LP-SS.

### Extended DRX & LP-WUS

The UE may be configured by upper layers and/or RRC with an extended DRX (eDRX) cycle T_E_DRX_CN and/or T_E_DRX_RAN. The UE operates in eDRX for CN paging in RRC_IDLE or RRC_INACTIVE states if the UE is configured for eDRX by upper layers and eDRX-AllowedIdle is signalled in SIB1. The UE operates in eDRX for RAN paging in RRC_INACTIVE state if the UE is configured for eDRX by RAN and eDRX-AllowedInactive is signalled in SIB1. If the UE operates in eDRX with an eDRX cycle no longer than 1024 radio frames, it monitors POs with configured eDRX cycle. Otherwise, a UE operating in eDRX monitors POs during a periodic Paging Time Window (PTW) configured for the UE. The PTW is UE-specific and is determined by a Paging Hyperframe (PH), a starting position within the PH (PTW_start) and an ending position (PTW_end). PH, PTW_start and PTW_end are given by the following formula:

The PH for CN is the H-SFN satisfying the following equations:
>1: H-SFN mod T_E_DRX_CN=(UE_ID_H mod T_E_DRX_CN), where
>>2: UE_ID_H: 13 most significant bits of the Hashed ID.
>>2: T_E_DRX_CN: UE-specific eDRX cycle in Hyper-frames, (T_E_DRX_CN=2, . . . , 1024 Hyper-frames) configured by upper layers.

PTW_start denotes the first radio frame of the PH that is part of the PTW and has SFN satisfying the following equation:

$$> 1 \text{:} SFN = 128 * {i}_{eDRX \_ CN} ,$$

$$where$$

$$>> 2 \text{:} {i}_{eDRX \_ CN} = floor ( UE\_ID \_H / T\_E \_DRX \_CN ) mod 8$$

PTW_end is the last radio frame of the PTW and has SFN satisfying the following equation:

$$> 1 \text{:} SFN = ( PTW\_start + L * 100 - 1 ) mod 1024 ,$$

$$where$$

$$>> 2 \text{:} L = Paging Time Window ( PTW ) length ( in seconds ) configured by upper layers$$

Hashed ID is defined as follows:
>1: Hashed_ID is Frame Check Sequence (FCS) for the bits b31, b30 . . . , b0 of 5G-S-TMSI.
>1: 5G-S-TMSI=<b47, b46, . . . , b0>.
>1: The 32-bit FCS shall be the ones complement of the sum (modulo 2) of Y1 and Y2, where
>>2: Y1 is the remainder of x^{k} (x³¹+x³⁰+x²⁹+x²⁸+x²⁷+x²⁶+x²⁵+x²⁴+x²³+x²²+x²¹+x²⁰+x¹⁹+x¹⁸+x¹⁷+x¹⁶+x¹⁵+x¹⁴+x¹³+x¹²+x¹¹+x¹⁰+x⁹+x⁸+x⁷+x⁶+x⁵+x⁴+x³+x²+x¹⁺¹) divided (modulo 2) by the generator polynomial x³²+x²⁶+x²³+x²²+x¹⁶+x¹²+x¹¹+x¹⁰+x⁸+x⁷+x⁵+x⁴+x²+x+1, where k is 32; and
>>2: Y2 is the remainder of Y3 divided (modulo 2) by the generator polynomial x³²+x²⁶+x²³+x²²+x¹⁶+x¹²+x¹¹+x¹⁰+x⁸+x⁷+x⁵+x⁴+x²+x+1, where Y3 is the product of x³² by “b31, b30 . . . , b0 of S-TMSI or 5G-S-TMSI”, i.e., Y3 is the generator polynomial x³² (b31*x³¹+b30*x³⁰+ . . . +b0*1).

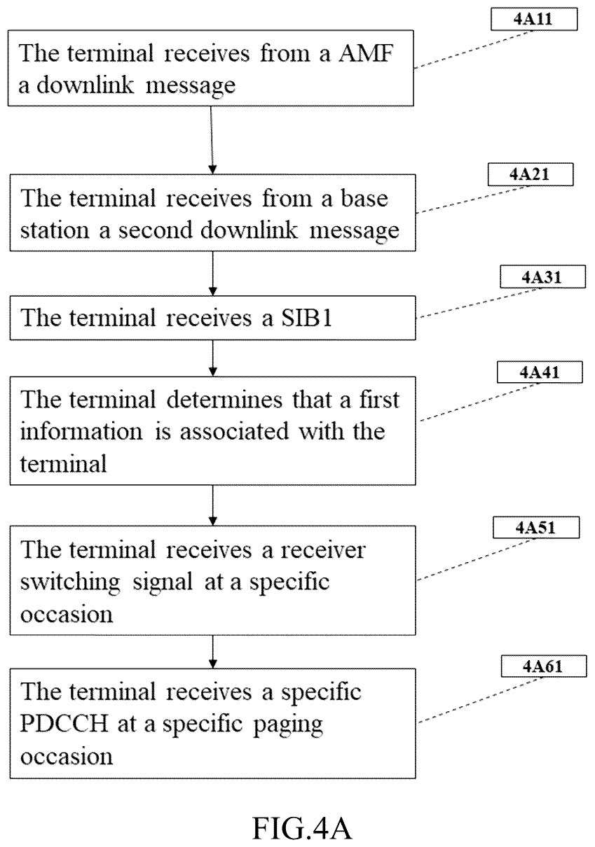

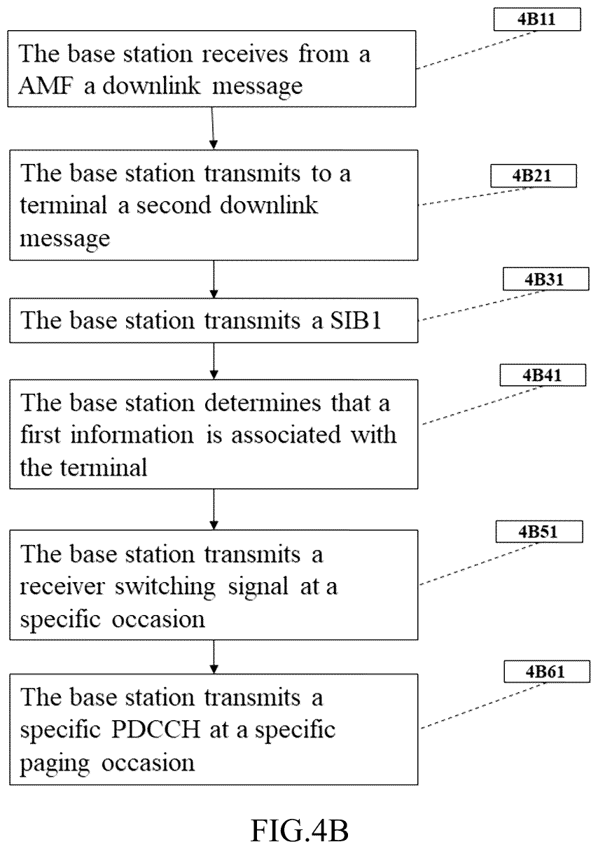

FIG. 4A illustrates operation of terminal to receive WUS.

When relevant WUS is detected by the terminal, the terminal turns off the LR and turns on the MR. In that sense, WUS can be considered as receiver switching signal.

The terminal may perform followings.

The terminal receives from an AMF a downlink message, 4A11 wherein the downlink message comprises a first parameter related to receiver switching signal [subgroup ID].

The terminal receives from a base station a second downlink message 4A21 [RRCRelease], wherein the second downlink message instructs the terminal to perform state transition to RRC_INACTIVE state.

The terminal receives a SIB1 4A31, wherein the SIB1 comprises a second parameter related to receiver switching signal [subgroupsNumPerPO].

The terminal determines that a first information [code sequence associated with the subgroup of the UE] is associated with the terminal 4A41 based on:
the first parameter related to receiver switching signal; and
the second parameter related to receiver switching signal;

The terminal receives a receiver switching signal at a specific occasion 4A51, wherein the receiver switching signal comprises the first information; and

The terminal receives a specific PDCCH [Paging DCI] at a specific paging occasion 4A61,
wherein the specific paging occasion is associated with the specific occasion,
wherein:
   the receiver switching signal is received by a first receiver; and
   the specific paging occasion is received by a second receiver,
wherein:
   the receiver switching signal is monitored during a first time window [WTW]; and
   the specific paging occasion is monitored during a second time window [PTW];
wherein the first time window and the second time window:
   have a same duration; and
   starts at different time points,
wherein:
   the first time window starts earlier than the second time window by a specific amount of time; and
the specific amount of time [actual_offset] is indicated by a specific parameter comprised in the SIB1 [minimum_offset],
wherein:
   the duration of the first time window and the second time window are determined based on a specific parameter comprised in the downlink message.

FIG. 4B illustrates operation of base station to transmit WUS.

The base station may perform followings.

The base station receives from a AMF a downlink message 4B11, wherein the downlink message comprises a first parameter related to receiver switching signal [subgroup ID].

The base station transmits to a terminal a second downlink message 4B21 [RRCRelease], wherein the second downlink message instructs the base station to perform state transition to RRC_INACTIVE state.

The base station transmits a SIB1 4B31, wherein the SIB1 comprises a second parameter related to receiver switching signal [subgroupsNumPerPO].

The base station determines that a first information [code sequence associated with the subgroup of the UE] is associated with the terminal 4B41 based on:
the first parameter related to receiver switching signal; and
the second parameter related to receiver switching signal;
The base station transmits a receiver switching signal at a specific occasion 4B51, wherein the receiver switching signal comprises the first information; and

The base station transmits a specific PDCCH [Paging DCI] at a specific paging occasion 4B61,
wherein:
   the receiver switching signal is transmitted by a first transmiter; and
   the specific PDCCH [Paging DCI] at a specific paging occasion is transmitted by a second transmiter,
wherein:
   the receiver switching signal is monitored during a first time window [WTW]; and
   the specific paging occasion is monitored during a second time window [PTW];
wherein the first time window and the second time window:
   have a same duration; and
   starts at different time points,
wherein:
   the first time window starts earlier than the second time window by a specific amount of time; and
   the specific amount of time [actual_offset] is indicated by a specific parameter comprised in the SIB1 [minimum_offset],
wherein:
   the duration of the first time window and the second time window are determined based on a specific parameter comprised in the downlink message.

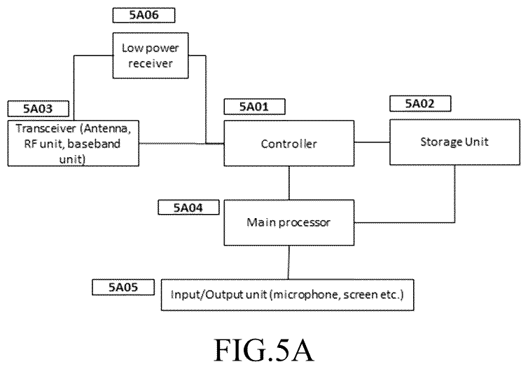

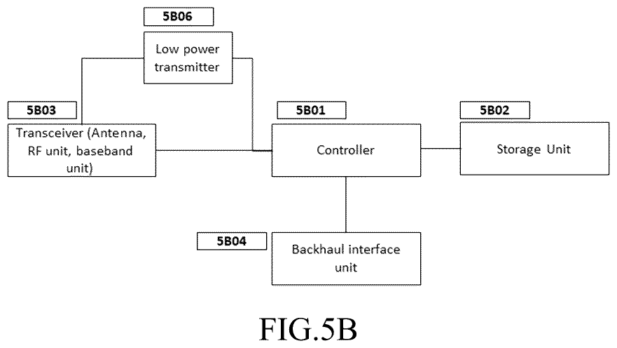

FIG. 5A is a block diagram illustrating the internal structure of a UE to which the disclosure is applied.

Referring to the diagram, the UE includes a controller 5A01, a storage unit 5A02, a transceiver 5A03, a main processor 5A04, I/O unit 5A05 and low power receiver 5A06.

The controller 5A01 controls the overall operations of the UE in terms of mobile communication. For example, the controller 5A01 receives/transmits signals through the transceiver 5A03 and through the low power receiver. In addition, the controller 5A01 records and reads data in the storage unit 5A02. To this end, the controller 5A01 includes at least one processor. For example, the controller 5A01 may include a communication processor (CP) that performs control for communication and an application processor (AP) that controls the upper layer, such as an application program. The controller controls storage unit and transceiver such that UE operations illustrated in the present disclosure are performed.

The storage unit 5A02 stores data for operation of the UE, such as a basic program, an application program, and configuration information. The storage unit 5A02 provides stored data at a request of the controller 5A01.

The transceiver 5A03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 5A04 controls the overall operations other than mobile operation. The main processor 5A04 process user input received from I/O unit 5A05, stores data in the storage unit 5A02, controls the controller 5A01 for required mobile communication operations and forward user data to I/O unit 5A05.

I/O unit 5A05 consists of equipment for inputting user data and for outputting user data such as a microphone and a screen. I/O unit 5A05 performs inputting and outputting user data based on the main processor's instruction.

Low power receiver 5A06 is connected with antenna part of the transceiver and controller. Low power receiver process LP-SS and LP-WUS based on controller's control.

FIG. 5B is a block diagram illustrating the configuration of a base station according to the disclosure.

As illustrated in the diagram, the base station includes a controller 5B01, a storage unit 5B02, a transceiver 5B03 a backhaul interface unit 5B04 and low power transmitter 5B06.

The controller 5B01 controls the overall operations of the main base station. For example, the controller 5B01 receives/transmits signals through the transceiver 5B03 or through low power transmitter or through the backhaul interface unit 5B04. In addition, the controller 5B01 records and reads data in the storage unit 5B02. To this end, the controller 5B01 may include at least one processor. The controller controls transceiver, storage unit and backhaul interface such that base station operation illustrated in the present disclosure are performed.

The storage unit 5B02 stores data for operation of the main base station, such as a basic program, an application program, and configuration information. Particularly, the storage unit 5B02 may store information regarding a bearer allocated to an accessed UE, a measurement result reported from the accessed UE, and the like. In addition, the storage unit 5B02 may store information serving as a criterion to deter mine whether to provide the UE with multi-connection or to discontinue the same. In addition, the storage unit 5B02 provides stored data at a request of the controller 5B01.

The transceiver 5B03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 5B04 provides an interface for communicating with other nodes inside the network. The backhaul interface unit 5B04 converts a bit string transmitted from the base station to another node, for example, another base station or a core network, into a physical signal, and converts a physical signal received from the other node into a bit string.

Low power transmitter 5B06 is connected with antenna part of the transceiver and controller. Low power transmitter processes LP-SS and LP-WUS based on controller's control.

What is claimed is:

1. A method performed by a terminal, the method comprising:
receiving by the terminal from Access and Mobility Management Function (AMF) a downlink message, wherein the downlink message comprises a first parameter related to receiver switching signal;
receiving by the terminal from a base station a second downlink message, wherein the second downlink message instructs the terminal to perform state transition to RRC_INACTIVE state;
receiving by the terminal a SIB1, wherein the SIB1 comprises a second parameter related to receiver switching signal;
determining by the terminal that a first information is associated with the terminal based on:
the first parameter related to receiver switching signal; and
the second parameter related to receiver switching signal;
receiving by the terminal a receiver switching signal, wherein the receiver switching signal comprises the first information; and
monitoring by the terminal a specific paging occasion,
wherein:
the receiver switching signal is received by a first receiver; and
the specific paging occasion is monitored by a second receiver,
wherein:
the receiver switching signal is monitored during a first time window; and
the specific paging occasion is monitored during a second time window;
wherein the first time window and the second time window:
have a same duration; and
starts at different time points,
wherein:
the first time window starts earlier than the second time window by a specific amount of time; and
the specific amount of time is indicated by a specific parameter comprised in the SIB1,
wherein:
the same duration of the first time window and the second time window are determined based on a specific parameter comprised in the downlink message.

2. A terminal comprising:
a transceiver,
a memory, and
a controller coupled to the transceiver and the memory, wherein the controller is configured to cause the terminal to:
receive from Access and Mobility Management Function (AMF) a downlink message, wherein the downlink message comprises a first parameter related to receiver switching signal;
receive from a base station a second downlink message, wherein the second downlink message instructs the terminal to perform state transition to RRC_INACTIVE state;
receive a SIB1, wherein the SIB1 comprises a second parameter related to receiver switching signal;
determining by the terminal that a first information is associated with the terminal based on:
the first parameter related to receiver switching signal; and
the second parameter related to receiver switching signal;
receive a receiver switching signal, wherein the receiver switching signal comprises the first information; and
receive a downlink control information at a specific paging occasion,
wherein:
the receiver switching signal is received by a first receiver; and
the specific paging occasion is received by a second receiver,
wherein:
the receiver switching signal is monitored during a first time window; and
the specific paging occasion is monitored during a second time window;
wherein the first time window and the second time window:
have a same duration; and
starts at different time points,
wherein:
the first time window starts earlier than the second time window by a specific amount of time; and
the specific amount of time is indicated by a specific parameter comprised in the SIB1,
wherein:
the same duration of the first time window and the second time window are determined based on a specific parameter comprised in the downlink message.
